(19) United States
(12) Patent Application Publication
(10) Pub. No.: US 2008/0087129 A1
(43) Pub. Date: Apr. 17, 2008

(54) Tilt And Telescopic Type Steering System For Vehicle Use

(76) Inventors: Kazuhisa Kaneko, Gunma (JP); Masaharu Igarashi, Gunma (JP)

Correspondence Address: SUGHRUE MION, PLLC, 2100 PENNSYLVANIA AVENUE, N.W., SUITE 800, WASHINGTON, DC, 20037, US

(21) Appl. No.: 11/628,481

(22) PCT Filed: May 31, 2005
(86) PCT No.: PCT/JP05/09987

§ 371 Date: Dec. 1, 2006

(30) Foreign Application Priority Data
Jun. 1, 2004 (JP) 2004-163471

(51) Int. Cl. B62D 1/18

(52) U.S. Cl. 74/493

(57) ABSTRACT

[Problems]To further improve the operation property at the time of making a tilt and telescopic adjustment and reduce the number of parts and adjust the starting load at the time of a secondary collision. [Means for Resolution]

On the outside of opposing flat plate portions 14, 14 of a vehicle body side bracket 11, friction plates 26, 26 for tilting are attached. Between these friction plates 26, 26, friction plates 27, 27 for telescoping are provided. On the friction plates 26, 26 for tilting, slotted holes 26a for tilting are formed corresponding to slotted holes 15 for tilting. On the friction plates 27, 27 for telescoping, slotted holes 27a for telescoping are formed corresponding to a telescopic adjustment range. The slotted holes 15, 26a for tilting are formed into a straight shape and perpendicular to an axis of an upper column 2.

### TECHNICAL FIELD

The present invention relates to a tilt and telescopic type steering system for vehicle use capable of adjusting a steering wheel at an appropriate position when a steering column is subjected to a tilt and telescopic adjustment.

### RELATED ART

In the case of a steering column system used for a vehicle which is used (steered) by an unspecific person, it is desirable that a steering wheel position can be adjusted according to a physical constitution and driving posture of the person to steer the steering wheel. In order to meet the demand, a tilt type mechanism or a telescopic type mechanism is adopted in many cases.

The tilt type mechanism is a mechanism for adjusting a steering wheel position in a substantial vertical direction. This tilt type mechanism includes: a tilt pivot for supporting a steering column so that the steering column can be freely oscillated; and a tilt and clamp means for clamping the steering column at a desired position (at a desired oscillating angle).

The telescopic mechanism is a mechanism for adjusting the steering wheel position in the longitudinal direction (the axial direction of the steering shaft). The telescopic mechanism includes: a duplex tube type expanding and contracting portion for expanding and contracting the steering column; and a telescopic and clamp means for clamping the steering column at a predetermined position (by a predetermined amount of expansion and contraction).

In the case where an automobile collides with an obstacle, the driver secondarily collides with a steering wheel by inertia in some cases. In the case of a passenger car, recently, a collapsible steering shaft or a collapsible steering column device has been widely adopted in order to avoid an injury given to the driver in the case of the secondary collision with the steering wheel. The collapsible steering column device is composed in such a manner that the steering column is broken away together with the steering shaft in the case of the secondary collision of the driver. Usually, the steering column collapses simultaneously with the steering shaft. At this time, the collision energy is absorbed.

In this connection, in the above tilt type mechanism, a pair of clamp portions of the steering column are arranged between a pair of opposing flat plates of the tilt bracket on the vehicle body side. Between a head portion of a fastening bolt and one of the opposing flat plates of the tilt bracket and between a lock mechanism on an operation lever side and the other opposing flat plate of the tilt bracket, a multiple disc type friction engaging mechanism is provided.

In this multiple disc type friction engaging mechanism, on outer faces of the opposing flat plates, friction plates used for tilting are respective provided. Between these friction plates used for tilting, friction plates used for telescoping are provided.

On the friction plates used for tilting, slotted holes for tilting are formed corresponding to the slotted holes for tilting formed on a pair of opposing flat plates. On the friction plates used for telescoping, slotted holes for telescoping are formed corresponding to a telescopic adjustment range.

In the case of conducting a tilt and telescopic fastening, when the operation lever is rotated in one direction, the lock mechanism is rotated, and a fastening bolt to be not rotated is pulled in the axial direction. Therefore, a pair of opposing flat plates and the friction plate for tilting are fastened to each other. Further, a pair of opposing flat plates and the friction plate for telescoping are fastened to each other.

As a result, an interval between a pair of opposing flat plates is reduced. Therefore, a pair of clamp portions are fastened. Due to the foregoing, a pair of clamp portions come into pressure contact with the inner column. Therefore, a pair of clamp portions hold the inner column. In this way, the tilt and telescopic fastening can be accomplished.

When the friction plates for tilting and the friction plates for telescoping are provided in this way, a holding force (a fastening force) of the steering column at the time of the tilt and telescopic fastening can be increased. Therefore, it is possible to enhance a holding force especially at the time of a secondary collision.

Further, when the number of these friction plates is appropriately changed, it is possible to adjust a starting load at the time of a secondary collision. Therefore, it is possible to evade a synchronization with a capsule for releasing.

Patent Document 1: Official gazette of JP-A-10-35511

### DISCLOSURE OF THE INVENTION

Problems that the Invention is to Solve

However, in the constitution of the multiple disc type friction engaging mechanism disclosed in Patent Document 1 described above, the number of parts is large. Therefore, unless a positional relation between parts to attach the friction plates is accurately maintained, it becomes impossible to ensure an operation property at the time of making a tilt and telescopic adjustment.

The present invention has been accomplished in view of the above circumstances. An object of the present invention is to provide a tilt and telescopic type steering system for vehicle use characterized in that: an operation property at the time of making the tilt and telescopic adjustment is further improved; a number of parts is reduced; and a starting load at the time of a secondary collision can be adjusted.

Means for Solving the Problems

In order to accomplish the above object, according to claim 1, there is provided a tilt and telescopic type steering system for vehicle use, a steering wheel of which can be adjusted at an appropriate position by making a tilt and telescopic adjustment on a steering column, including:

a multiple disc type friction engaging mechanism arranged between a head portion of a fastening bolt and one of the opposing flat plates of a vehicle body side bracket and between a lock mechanism on an operation lever side and the other opposing flat plate of the body side bracket, wherein

friction plates for tilting are attached to the outside of the opposing flat plates in the multiple disc type friction engaging mechanism and friction plates for telescoping are arranged between the friction plates for tilting,

a slotted hole for tilting is formed on the friction plate for tilting corresponding to a slotted hole for tilting in a pair of the opposing flat plates and a slotted hole for telescoping is formed on the friction plate for telescoping corresponding to a telescopic adjustment range, and

the slotted hole for tilting is formed into a straight shape and perpendicular to an axis of the steering column.

According to claim 2, there is provided the tilt and telescopic type steering system for vehicle use, wherein

a fixing means of the friction plate for tilting is arranged only on one side of the central axis of the slotted hole for tilting.

According to claim 3, there is provided the tilt and telescopic type steering system for vehicle use, wherein

a head portion of a fastening bolt inserted into slotted holes for tilting and telescoping is formed into a not-circular shape, and

a spacer member is provided, the spacer member having a groove wall portion for maintaining the not-circular head portion of the fastening bolt in a not-rotating state and having a protruding portion engaging and sliding in the slotted hole for tilting.

Advantage of the Invention

According to the present invention, the slotted hole for tilting is formed into a straight shape and perpendicular to the axis of the steering column.

The background of the slotted hole for tilting of the present invention is described as follows. In the case of making only a tilt adjustment, a slotted hole for tilting is usually formed into a curved shape formed round a tilt pivot. However, it is difficult to conduct machining to form this curved shape. Therefore, the slotted hole for tilting is formed into a wide straight shape, the inside of which includes a locus of the curve of the fastening bolt. However, in this case, the slotted hole for tilting is relatively wide. Therefore, a gap between the fastening bolt and the slotted hole for tilting is extended. Accordingly, a position of the operation lever is not stable. Further, when the operation lever is released, much backlash is generated.

Therefore, not only in the case of making a tilt adjustment but also in the case of making a tilt and telescopic adjustment, a slotted hole for telescoping is added. Therefore, the slotted hole for tilting can be formed into a straight shape while the gap is being maintained small. Even when tilting is conducted while the column engaging length is being maintained constant, the slotted hole for tilting and the slotted hole for telescoping are excellently combined with each other. Therefore, even when the slotted hole for tilting is a straight shape and the gap is small, operation can be smoothly conducted.

Accordingly, in the structure of the present invention, the slotted hole for tilting is formed into a straight shape and perpendicular to the axis of the steering column. In this connection, at the time of machining the slotted hole for tilting, it is necessary to conduct burring on the outermost friction plate. This burring can be more easily conducted on a straight shape than a curved shape.

A fixing means for fixing the friction plate for tilting is arranged only on one side of the center line of the slotted hole for tilting. Therefore, the number of parts can be reduced. Further, by the effect of a gap formed between the fastening bolt and the slotted hole for tilting, the operation property at the time of making a tilt and telescopic adjustment can be further improved.

The background is described as follows. When both sides of the friction plate for tilting are attached as conventionally conducted, the degree of freedom of deformation of the friction plate for tilting is reduced. On the other hand, when one side of the friction plate for tilting is attached, the degree of freedom of deformation of the friction plate for tilting is increased. Especially, the degree of freedom in the direction perpendicular to the surface of the friction plate for tilting is increased. Therefore, when the friction plates are moved in the other directions, the tilt and telescopic adjustment can be smoothly conducted.

Further, when the friction plates are fixed while elastic bodies are being interposed between the friction plates, the friction plates are actively separated from each other at the time of loosening the fastening bolt. Therefore, operation can be more smoothly conducted.

A fixing portion is arranged on the central axis of the slotted hole for tilting. Therefore, even when a positional adjustment is made by loosening the fastening bolt, there is no possibility that the friction plate is rotated.

Concerning the fastening bolt inserted into the slotted hole for tilting and also inserted into the slotted hole for telescoping, a head portion of the fastening bolt is formed into a not-circular shape. Further, a spacer member is provided which includes a groove wall portion for maintaining the not-circular head portion of the fastening bolt in a not-rotating state and also includes a protruding portion engaging with and sliding in the slotted hole for tilting.

Accordingly, at the time of releasing a tilt and telescopic state, while the not-circular head portion of the fastening bolt is being maintained in a not-rotating state by the groove wall portion of the spacer member, the head portion of the fastening bolt can slide a little. Further, when this sliding direction is directed in the width direction of the slotted hole for tilting, rattling can be made a little between the groove for tilting and the shaft portion of the fastening bolt corresponding to the gap formed between them. By the effect of this rattling, the operation property at the time of releasing the tilt and telescopic state can be further improved.

Further, when the friction plate for tilting and the friction plate for telescoping are provided, a holding force (a fastening force) of the steering column is increased at the time of conducting the tilt and telescopic fastening. Especially, it is possible to enhance a holding force at the time of a secondary collision. When the steering column is broken away from the vehicle body at the time of the secondary collision, a plurality of friction plates are not slid.

Further, when the number of the friction plates of the multiple disc type friction engaging mechanism is appropriately changed, it is possible to adjust a starting load at the time of the secondary collision. Therefore, it is possible to evade a synchronization with the capsule for releasing.

### BRIEF DESCRIPTION OF THE DRAWINGS

FIG. 1 is a side view showing a tilt and telescopic type steering system for vehicle use of the first embodiment of the present invention.

FIG. 2 is a rear view of the tilt and telescopic type steering system for vehicle use shown in FIG. 1.

FIG. 3 is a side view on an opposite side of the tilt and telescopic type steering system for vehicle use shown in FIG. 1.

FIG. 4 is a side view on an opposite side of the tilt and telescopic type steering system for vehicle use of the second embodiment of the present invention.

FIG. 5 is a sectional view showing a neighborhood of a bolt attaching portion for fixing a friction plate for tilting of a tilt and telescopic type steering system for vehicle use of the third embodiment of the present invention, wherein FIG. 5 is an enlarged sectional view corresponding to V in FIG. 2.

FIG. 6 is a sectional view showing a neighborhood of a bolt attaching portion for fixing a friction plate for tilting of a tilt and telescopic type steering system for vehicle use of a variation of the third embodiment of the present invention, wherein FIG. 6 is an enlarged sectional view corresponding to V in FIG. 2.

FIG. 7 is a side view showing a tilt and telescopic type steering system for vehicle use of the fourth embodiment of the present invention.

FIG. 8 is a side view showing a tilt and telescopic type steering system for vehicle use of the fifth embodiment of the present invention.

FIG. 9 is a side view showing a state in which the steering system shown in FIG. 8 has collapsed in a secondary collision.

FIG. 10 is a side view showing a tilt and telescopic type steering system for vehicle use of the sixth embodiment of the present invention.

FIG. 11 is a side view showing a state in which the steering system shown in FIG. 10 has collapsed in a secondary collision.

### DESCRIPTION OF THE REFERENCE NUMERALS AND SIGNS

1 Lower column

2 Upper column

3 Steering shaft

11 Upper vehicle body side bracket

12 Capsule for releasing

13 Vehicle body attaching portion

14 Opposing flat plate portion

15 Slit for tilting

20 Clamp portion

S Slit

21 Through-hole

22a, 22b Cam member

23 Operation lever

24 Thrust bearing

25 Nut

26 Friction plate

26a Slotted hole

27 Friction plate

27a Slotted hole

28, 29 Bolt

30 Fastening bolt

31 Heat-portion

31a Flat face

32 Spacer member

33 Groove wall portion

34 Protruding portion

35 Flange

### BEST MODE FOR CARRYING OUT THE INVENTION

Referring to the drawings, a tilt and telescopic type steering system for vehicle use of each embodiment of the present invention will be explained below.

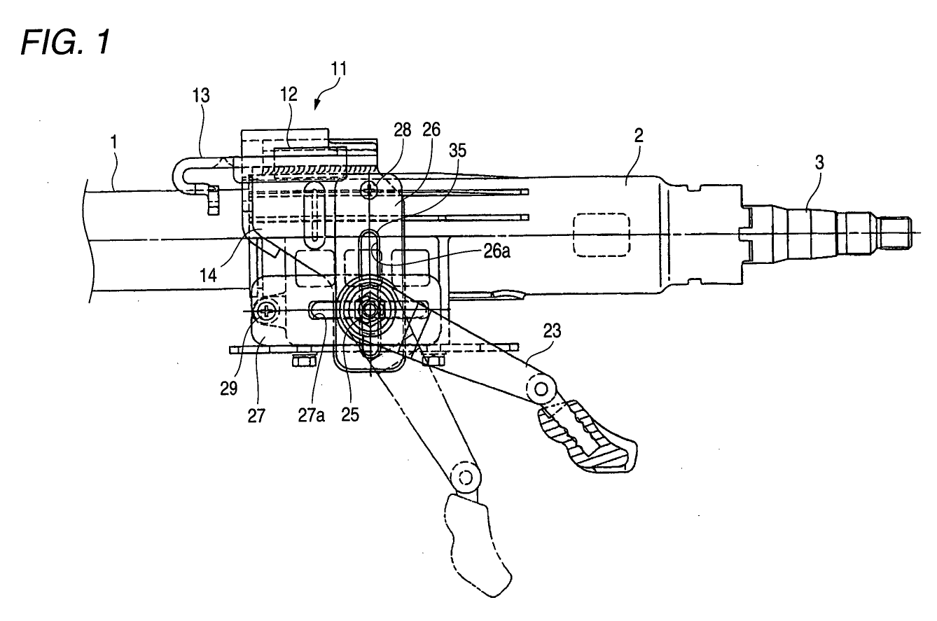

FIG. 1 is a side view showing a tilt and telescopic type steering system for vehicle use of the first embodiment of the present invention.

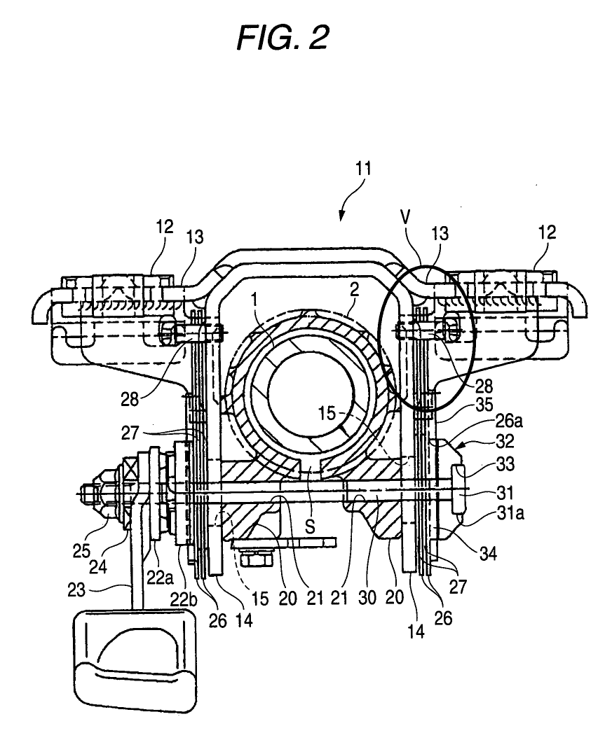

FIG. 2 is a rear view of the tilt and telescopic type steering system for vehicle use shown in FIG. 1.

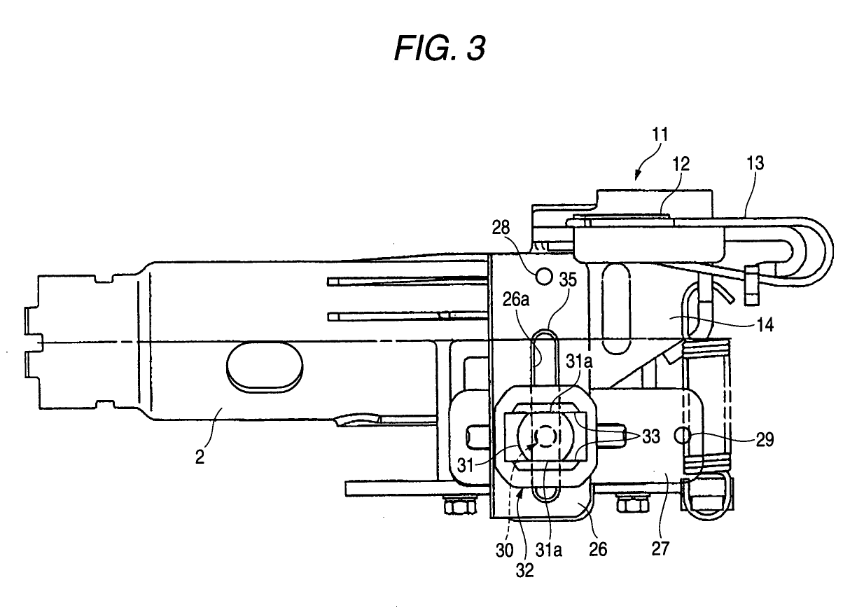

FIG. 3 is a side view on an opposite side of the tilt and telescopic type steering system for vehicle use shown in FIG. 1.

As shown in FIGS. 1 and 2, the present embodiment is composed as follows. A steering column includes: a lower column 1 attached to a vehicle body so that the lower column 1 can be freely oscillated; and an upper column 2 engaged with this lower column 1 so that the upper column 2 can be telescopically slid on the lower column 1. At the time of a secondary collision of a vehicle, the steering column can collapse and contract. In both the columns 1, 2, a steering shaft 3 is pivotally arranged.

In a front portion of the upper column 2, an upper vehicle body side bracket 11 is provided. This upper vehicle body side bracket 11 includes: a pair of vehicle body attaching portions 13, 13 to be attached to a vehicle body via capsules 12, 12 for releasing at the time of a secondary collision; and a pair of opposing flat plate. portions 14, 14 which are extended from the vehicle body attaching portions 13, 13 in the substantially vertical direction being opposed to each other. In the pair of the opposing flat plate portions 14, 14, a pair of slotted holes 15, 15 for tilting are respectively formed.

In this upper vehicle body side bracket 11, a clamp mechanism used for making a tilt and telescopic adjustment is provided.

In the front portion of the upper column 2, a pair of thick clamp portions 20, 20 are provided which are formed in the column diameter direction and in the vehicle width direction via slit S and hold the lower column 1 and squeeze and release the lower column 1 when the thick clamp portions 20, 20 are expanded and contracted.

In the pair of clamp portions 20, 20, a pair of through-holes 21, 21 are formed. A fastening bolt 30 is inserted into these through-holes 21, 21.

Onto a screw portion side of this fastening bolt 30, a cam lock mechanism composed of a pair of cam members 22a, 22b, an operation lever 23 and a nut 25 are attached. In this case, the nut 25 is attached through a thrust bearing 24.

In this connection, the cam lock mechanism includes: a first cam member 22a rotated together with the operation lever 23, having a top portion and a bottom portion; and a second cam member 22b, which is not rotated, having a top portion and a bottom portion engaging with the top portion and the bottom portion of the first cam member 22a.

A multiple disc type friction engaging mechanism is used in this structure. That is, on the outside of the opposing flat plate portions 14, 14, friction plates 26, 26 for tilting are respectively attached. Between these friction plates 26, 26, friction plates 27, 27 for telescoping are arranged.

On the friction plates 26, 26 for tilting, slotted holes 26a for tilting are formed corresponding to the slotted holes 15 for tilting. On the friction plates 27, 27 for telescoping, slotted holes 27a for telescoping are formed corresponding to a telescopic adjustment range.

In this embodiment, the slotted holes 15, 26a for tilting are formed into a straight shape and perpendicular to an axis of the upper column 2.

The background of the slotted hole for tilting of the present invention is described as follows. In the case of making only a tilt adjustment, a slotted hole for tilting is usually formed into a curved shape round a tilt pivot. However, it is difficult to conduct machining to form this curved shape. Therefore, the slotted hole for tilting is formed into a wide straight shape, the inside of which includes a locus of the curve of the fastening bolt. However, in this case, the slotted hole for tilting is relatively wide. Therefore, a gap between the fastening bolt and the slotted hole for tilting is extended. Accordingly, a position of the operation lever is not stable. Further, when the operation lever is released, much backlash is generated.

Therefore, as explained in the present embodiment, not only in the case of making a tilt adjustment but also in the case of making a tilt and telescopic adjustment, slotted holes 21, 27a for telescoping are added. Therefore, the slotted holes 15, 26a for tilting can be formed into a straight shape while the gap is being maintained small. Even when tilting is conducted while the column engaging length is being maintained constant, the slotted holes 15, 26a for tilting and the slotted holes 21, 27a for telescoping are excellently combined with each other. Therefore, even when the slotted holes 15, 26a for tilting is a straight shape and the gap is small, operation can be smoothly conducted.

Due to the foregoing, in the structure of the present embodiment, the slotted -holes 15, 26a for tilting are formed into a straight shape and perpendicular to the axis of the upper column 2. In this connection, at the time of machining the slotted holes 15, 26a for tilting, it is necessary to conduct burring on the slotted holes 15, 26a for tilting on the outermost friction plate 26 for tilting. This burring can be more easily conducted on a straight shape than a curved shape.

A bolt 28 of the fixing means for fixing the friction plate 26 for tilting is arranged only on one side (an upper side) of the center line of the slotted hole 26a for tilting. Therefore, the number of parts can be reduced. Further, by the effect of a gap formed between the fastening bolt 30 and the slotted hole 26a for tilting, the operation property at the time of making a tilt and telescopic adjustment can be further improved.

The background is described as follows. When both sides of the friction plate for tilting are attached as conventionally conducted, the degree of freedom of deformation of the friction plate for tilting is reduced. On the other hand, like the present embodiment, when one side (an upper side) of the friction plate for tilting is attached, the degree of freedom of deformation of the friction plate for tilting is increased. Especially, the degree of freedom in the direction perpendicular to the friction plate 26 for tilting is increased. Therefore, when the friction plates 26 and the friction plates 27 for telescoping are moved in the other directions, the tilt and telescopic adjustment can be smoothly conducted.

In this connection, the friction plates 27 for telescoping are fixed in such a manner that only the front side of the friction plates 27 for telescoping with respect to the vehicle is fixed with bolts 29.

The head portion 31 of the fastening bolt 30 inserted into the slotted holes 15, 26a for tilting and the slotted holes 21, 27a for telescoping is formed into a not-circular shape. This head portion 31 of the fastening bolt 30 includes a pair of flat faces 31a and a spacer member 32.

This spacer member 32 includes: a groove wall portion 33 engaged with a flat face 31a of the not-circular head portion 31 so as to slidably maintain the head portion 31 of the bolt 30 in a not-rotary state; and a protruding portion 34 engaging with and sliding on the slotted hole 26a for tilting on the friction plate 26 for tilting.

In this connection, the slotted hole 26a for tilting, with which the protruding portion 34 is slidably engaged, is subjected to burring, and a flange 35 is perpendicularly arranged in the periphery of the slotted hole 26a for tilting.

Accordingly, at the time of releasing the tilt and telescopic state, the not-circular head portion 31 of the fastening bolt 30 is maintained in a not-rotary state by the groove wall portion 33 of the spacer member 32, however, it can be slid a little. Further, when the sliding direction of the head portion 31 of the fastening bolt 30 is directed in the width direction of the slotted hole 26a for tilting, that is, when the flat face 31a of the head portion 31 and the groove wall portion 33 extend in the axial direction of the upper column 2 as shown in FIG. 3, rattling, which corresponds to a small gap, can be caused between the grooves 15, 26a for tilting and the shaft portion of the fastening bolt 30. By this rattling effect, the operation property can be further improved at the time of releasing the tilt and telescopic state.

Further, when the friction plate 26 for tilting and the friction plate 27 for telescoping are provided, a holding force (a fastening force) of the upper column 2 is increased at the time of the tilt and telescopic fastening state. Therefore, it is possible to increase a holding force at the time of a secondary collision. When the upper column 2 is released from a vehicle body at the time of a secondary collision, a plurality of friction plates are not slid.

Further, when the number of the friction plates 26, 27 of the multiple disc type engaging mechanism is appropriately changed, it is possible to adjust a starting load at the time of a secondary collision. Accordingly, it is possible to evade a synchronization with the capsule for releasing.

In this connection, the tilt and telescopic clamping mechanism is operated as follows.

In the case of making a tilt and telescopic adjustment, when the operation lever 23 is rotated in one direction, the first cam member 22a is rotated and the not-rotary fastening bolt 30 is released from being pulled in the axial direction. Therefore, the opposing flat plates 14, 14, a pair of clamp portions 20, 20 and the friction plates 26, 27, which have been fastened, can be released. That is, an interval between a pair of opposing flat plates 14, 14 is extended. Therefore, a pair of clamp portions 20, 20 are released from being fastened and the width is extended.

Due to the foregoing, the lower column 1, the upper column 2 and the steering shaft 3 are rotated round a tilt pivot (not shown) and it becomes possible to make a tilt adjustment.

When the upper column 2 and the steering shaft 3 are slid in the axial direction, it is possible to make a telescopic adjustment by a pair of clamp portions 20, 20, the width of which is extended.

On the other hand, in the case of conducting a tilt and telescopic fastening, when the operation lever 23 is rotated in the opposite direction, the first cam member 22a is rotated. Therefore, the not-rotary fastening bolt 30 is pulled in the axial direction. Accordingly, the not-rotary fastening bolt 30 fastens a pair of opposing flat plate portions 14, 14.

As a result, an interval between a pair of opposing flat plates 14, 14 is reduced and a pair of clamp portions 20, 20 are fastened to each other. Due to the foregoing, a pair of clamp portions 20, 20 come into pressure contact with the lower column 1 and hold it. In this way, the tilt and telescopic fastening can be made. At this time, since the friction plate 26 for tilting and the friction plate 27 for telescoping are provided, it is possible to increase a holding force (a fastening force) of the upper column 2.

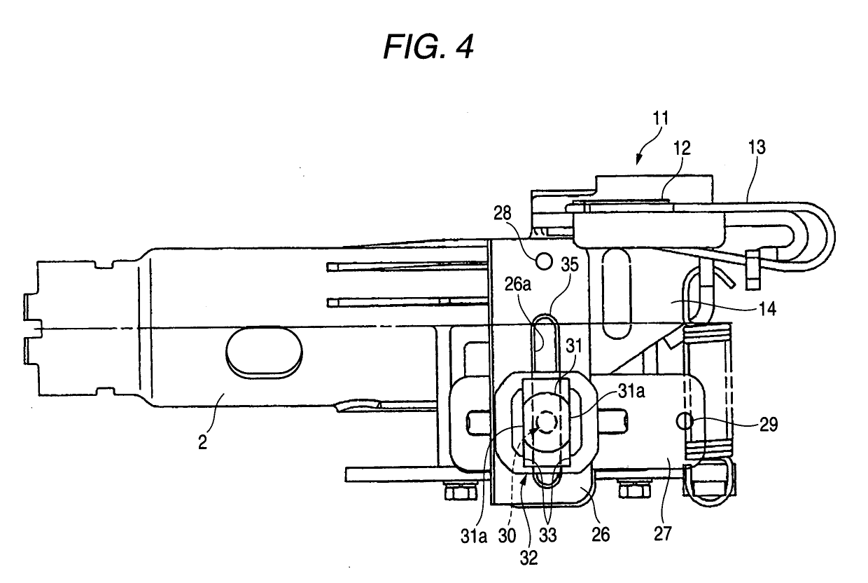

FIG. 4 is a side view on an opposite side of the tilt and telescopic type steering system for vehicle use of the second embodiment of the present invention.

In the first embodiment, at the time of releasing the tilt and telescopic state, the not-circular head portion 31 of the fastening bolt 30 is maintained in a not-rotary state by the groove wall portion 33 of the spacer member 32, however, it can be slid a little. Further, in the above embodiment, the sliding direction of the head portion 31 of the fastening bolt 30 is directed in the width direction of the slotted hole 26a for tilting, that is, the flat face 31a of the head portion 31 and the groove wall portion 33 extend in the axial direction of the upper column 2 as shown in FIG. 3.

On the other hand, in the present embodiment, the sliding direction is directed to the longitudinal direction of the slotted hole 26a for tilting. That is, as shown in FIG. 4, the flat face 31a of the head portion 31 and the groove wall portion 33 are extended in a direction perpendicular to the axis of the upper column 2.

Due to the foregoing, in the present embodiment, between the grooves 15, 26a for tilting and the shaft portion of the fastening bolt 30, it is impossible that rattling is caused by an amount corresponding to a small gap. Therefore, it is impossible to provide a rattling effect. Accordingly, there is a possibility that the tilt and telescopic operation can not be smoothly executed. Unless a positional relation between the groove wall portion 33 and the slotted hole 26a for tilting is importantly controlled, a positional relation between the slotted hole 26a for tilting on the friction plate 26 for tilting and the slotted hole 15 for tilting of the opposing flat plate portion 14 is deteriorated a little, which affects the tilt and telescopic operation.

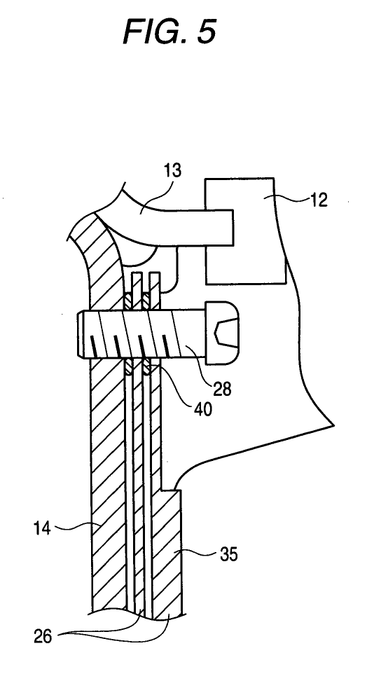

FIG. 5 is a sectional view showing a neighborhood of a bolt attaching portion for fixing a friction plate 26 for tilting of a tilt and telescopic type steering system for vehicle use of the third embodiment of the present invention, wherein FIG. 5 is an enlarged sectional view corresponding to V in FIG. 2.

As shown in FIG. 5, in the same manner as that of the first embodiment, a plurality of friction plates 26 for tilting is fixed by the bolt 28 arranged only on one side (the upper side) of the central axis of the slotted hole 26a for tilting (shown in FIG. 1). However, in the present embodiment, between the opposing friction plates 26 for tilting and between the opposing friction plates 26 for tilting and the opposing flat plate portions 14, an elastomer member 40 such as an O-ring, which is an elastic body, is further arranged.

By this elastomer member 40, the opposing friction plates 26 for tilting are separated from each other and further the opposing friction plates 26 for tilting and the opposing flat plate portions 14 are separated from each other. In this case, the elastomer member 40 has a shock absorbing function and a silencing function when the friction plates 26 for tilting and the friction plates 27 for telescoping are moved in different directions.

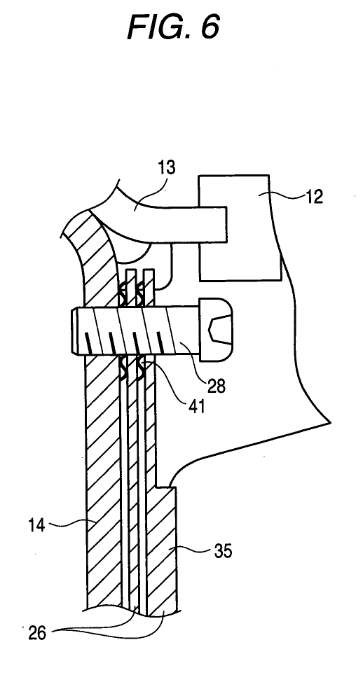

In this connection, as a variation of the present embodiment, instead of the elastomer member 40, a plate spring 41 such as a wave-washer, which is an elastic body, may be provided as shown in FIG. 6. Even in this variation, the same advantages as those described before can be provided.

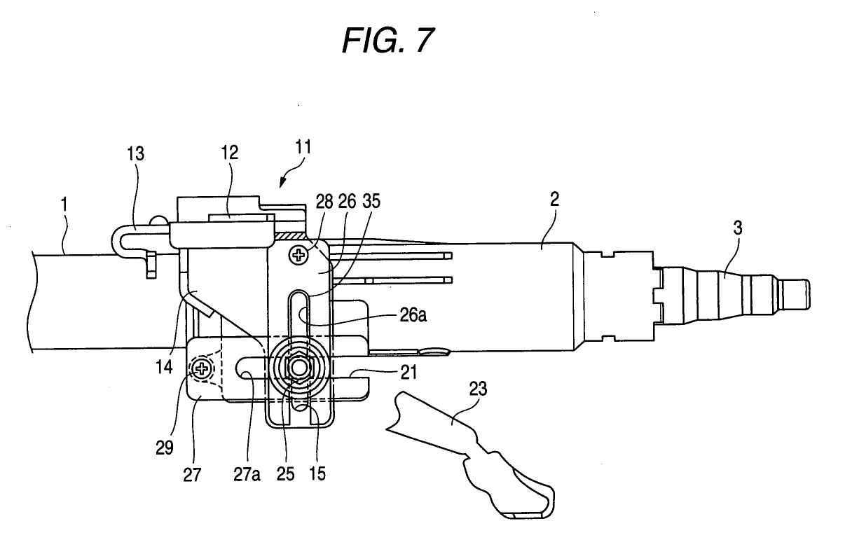

Next, FIG. 7 is a side view showing a tilt and telescopic type steering system for vehicle use of the fourth embodiment of the present invention.

In this embodiment, the slotted holes 21, 27a for telescoping, which are formed in a pair of clamp portions 20, 20 and the friction plates 27 for telescoping, are respectively formed into an open hole, the rear side of the vehicle of which is open. The slotted hole 26a for tilting formed on the friction plate 26 for tilting is formed into an open hole, the lower side of which is open. In this connection, in this embodiment, a pair of slotted holes 15 for tilting formed on a pair of opposing flat plate portions 14 are not open. However, the pair of slotted holes 15 for tilting formed on a pair of opposing flat plate portions 14 may be respectively an open hole which is open on the lower side in the same manner as that of the slotted holes 26a for tilting.

Due to the foregoing, when the slotted holes 21, 27a for telescoping and the slotted holes 26 for tilting are respectively formed into an open hole, the fastening bolt 30, to which the nut 25 is screwed and attached, can be inserted into these slotted holes 21, 27a, 26. Therefore, the assembling property can be enhanced. Other structure and operation are the same as those of the first embodiment.

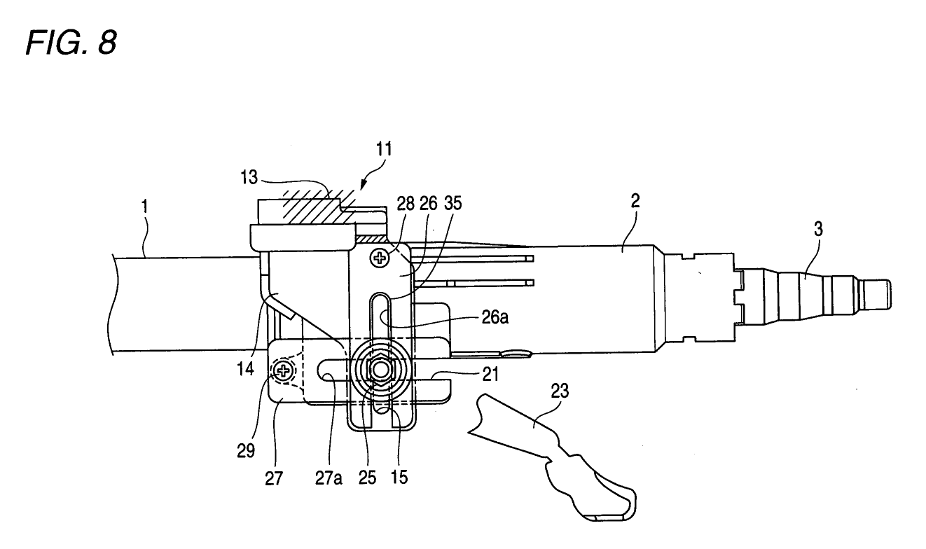

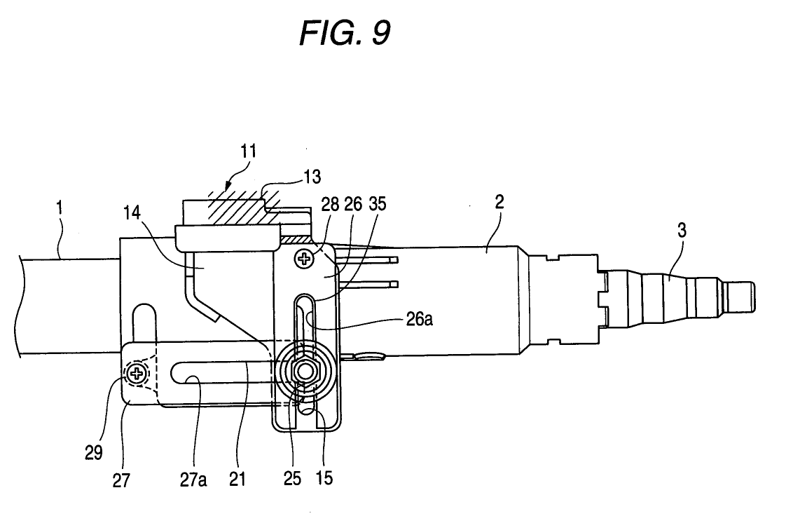

Next, FIG. 8 is a side view showing a tilt and telescopic type steering system for vehicle use of the fifth embodiment of the present invention, and FIG. 9 is a side view showing a state in which the steering system shown in FIG. 8 has collapsed in a secondary collision.

In this embodiment, the upper body side bracket 11 is attached to a vehicle body by a pair of vehicle body attaching portions 13 without using the capsule for releasing.

In this embodiment, the slotted holes 15, 26a for tilting and the slotted holes 21, 27a for telescoping are formed into the same shape as that of the fourth embodiment. That is, the slotted holes 21, 27a for telescoping, which are formed in the pair of clamp portions 20, 20 and the friction plates 27 for telescoping are respectively formed into an open hole which is open on the rear side of the vehicle, and the slotted holes 26a for tilting formed on the friction plates 26 for tilting are respectively formed into an open hole which is open on the lower side. In this connection, in this embodiment, a pair of slotted holes 15 for tilting formed on a pair of opposing flat plate portions 14 are not open. However, the pair of slotted holes 15 for tilting formed on a pair of opposing flat plate portions 14 may be respectively an open hole which is open on the lower side in the same manner as that of the slotted holes 26a for tilting.

In the tilt and telescopic type steering system for vehicle use of the present embodiment composed as described above, collision energy is absorbed at the time of a secondary collision as follows. When the upper column 2 collapses at time of the secondary collision, while the friction plates 26 for tilting and the friction plates 27 for telescoping are being slid on each other, the upper column 2 moves to the vehicle body front side with respect to the upper vehicle body side bracket 11 exceeding a telescopic stroke, so that the collision energy can be absorbed.

In this connection, in the case where a pair of slotted holes 15 for tilting, which are formed in the pair of opposing flat plate portion 14, are open holes which are open on the lower side, there is a possibility that the holes are expanded by a collapsing force. For the above reasons, it is desirable to adopt a structure in which the slotted holes 15 for tilting are not open.

In this embodiment, the slotted holes 15, 26a for tilting and the slotted holes 21, 27a for telescoping are formed into the same shape as that of the fourth embodiment, too. Therefore, the assembling property can be enhanced.

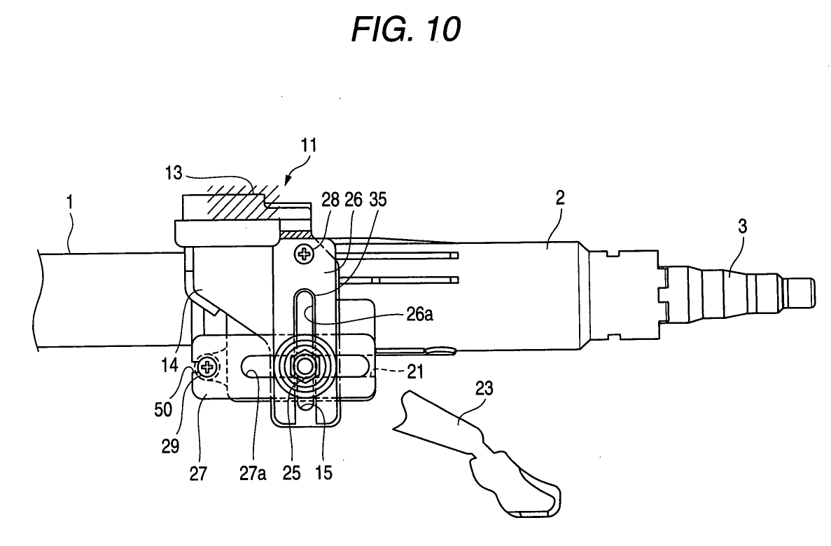

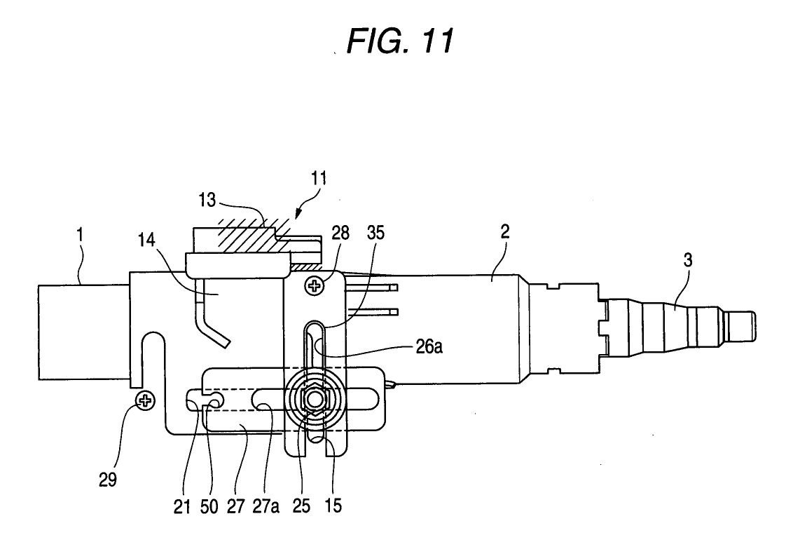

FIG. 10 is a side view showing a tilt and telescopic type steering system for vehicle use of the sixth embodiment of the present invention, and FIG. 11 is a side view showing a state in which the steering system shown in FIG. 10 has collapsed in a secondary collision.

In this embodiment, in the same manner as that of the fifth embodiment, the upper body side bracket 11 is attached to a vehicle body by a pair of vehicle body attaching portion 13 without using the capsule for releasing.

The slotted hole 27a for telescoping formed on the friction plate 27 for telescoping is a closed hole which is not open. The slotted hole 21 for telescoping formed on each of the pair of clamp portions 20 is an open hole which is open on the rear side of the vehicle. A bolt insertion hole 50, into which the bolt 29 is inserted for fixing the friction plate 27 for telescoping to the upper column 2, is formed into an open hole.

In this connection, the slotted holes 15, 26a for tilting, which are formed on the friction plates 26 for tilting and the pair of opposing flat plate portions 14, may be either open holes which are open to the lower side or closed holes which are not open. As described in the present embodiment, the slotted holes 26a for tilting may be open holes, and the slotted holes 15 for tilting may be closed holes which are not open.

In the tilt and telescopic type steering system for vehicle use of the present embodiment composed as described above, when the upper column 2 collapses at the time of a secondary collision, the bolt 29 is released from the bolt insertion hole 50 by the collision energy. Therefore, the upper column 2 is moved to the front side of the vehicle body with respect to the upper vehicle body side bracket 11 without sliding the friction plates 26 for tilting and the friction plates 27 for telescoping, so that the collision energy can be absorbed.

In this connection, it should be noted that the present invention is not limited to the above specific embodiment. Variations may be made without departing from the scope of claim of the present invention.

1. A tilt and telescopic type steering system for vehicle use, a steering wheel of which can be adjusted at an appropriate position by making a tilt and telescopic adjustment on a steering column, comprising:
a multiple disc type friction engaging mechanism arranged between a head portion of a fastening bolt and one of the opposing flat plates of a vehicle body side bracket and or between a lock mechanism on an operation lever side and the other opposing flat plate of the body side bracket, wherein
friction plates for tilting are attached to the outside of the opposing flat plates in the multiple disc type friction engaging mechanism and friction plates for telescoping are arranged between the friction plates for tilting,
a slotted hole for tilting is formed on the friction plate for tilting corresponding to a slotted hole for tilting in a pair of the opposing flat plates and a slotted hole for telescoping is formed on the friction plate for telescoping corresponding to a telescopic adjustment range, and
the slotted hole for tilting is formed into a straight shape and perpendicular to an axis of the steering column.

2. The tilt and telescopic type steering system for vehicle use according to claim 1, wherein
a fixing means of the friction plate for tilting is arranged only on one side of the central axis of the slotted hole for tilting.

3. The tilt and telescopic type steering system for vehicle use according to claim 1, wherein
a head portion of a fastening bolt inserted into slotted holes for tilting and telescoping is formed into a not-circular shape, and
a spacer member is provided, the spacer member having a groove wall portion for maintaining the not-circular head portion of the fastening bolt in a not-rotating state and having a protruding portion engaging and sliding in the slotted hole for tilting.
